(19) United States
(12) Patent Application Publication
(10) Pub. No.: US 2015/0175044 A1
(43) Pub. Date: Jun. 25, 2015

(54) VEHICLE SEAT

(71) Applicant: TS TECH CO., LTD., Asaka-shi, Saitama (JP)

(72) Inventor: Takeshi Akutsu, Shioya-gun (JP)

(21) Appl. No.: 14/418,517

(22) PCT Filed: Aug. 6, 2013
(86) PCT No.: PCT/JP2013/071204

§ 371 Date: Jan. 30, 2015

(30) Foreign Application Priority Data
Aug. 7, 2012 (JP) 2012-175449

(51) Int. Cl. B60N 2/68; B60N 2/64

(52) U.S. Cl. CPC B60N 2/686; B60N 2/646

(57) ABSTRACT

A vehicle seat (car seat S) includes a cushion member (seat back pad P), a support member (side frames 20) configured to support right and left portions of the cushion member, and a compressing member (skin member E and back board 50) configured to compress side portion constituent portions P31 which constitute the right and left portions of the cushion member.

### TECHNICAL FIELD

The present invention relates to a vehicle seat comprising a cushion member and a support member for supporting right and left portions of the cushion member.

### BACKGROUND ART

Conventionally, there is known a structure in which right and left portions of a cushion member are sandwiched and held, while they remain soft, by right and left frames and a skin member (see Patent Literature 1).

### CITATION LIST

### Patent Literature

Patent Literature 1: Japanese Laid-open Utility Model Application, Publication No. H06-185

### SUMMARY OF THE INVENTION

However, according to this conventional design, since the right and left portions of the cushion member remain soft, if a load is applied to the right portion or the left portion of the cushion member, the cushion member may be shifted excessively to the right or to the left.

In view of this drawback, the object of the present invention is to prevent the cushion member from being shifted excessively to the right or to the left.

To solve the above drawback, a vehicle seat according to the present invention comprises: a cushion member; a support member configured to support right and left portions of the cushion member; and a compressing member configured to compress side portion constituent portions which constitute the right and left portions of the cushion member.

With this configuration, since the side portion constituent portions which constitute the right and left portions of the cushion member are compressed and hardened by the compressing member, it is possible to more effectively prevent the cushion member from being shifted excessively to the right and to the left, for example, as compared to the configuration in which the right and left portions of the cushion member are supported by the support member while they remain soft.

The above vehicle seat may be configured such that the cushion member is put over the support member from a front side so as to support a back of an occupant, that a back board is provided at a rear side of the support member such that a gap is formed between each of right and left end portions of the back board and the support member, and that the side portion constituent portions are arranged to fill the gap formed between the support member and each of the right and left end portions of the back board.

In a configuration in which a gap is formed between the support member and each of right and left end portions of the back board, and the right and left portions of the cushion member are arranged to fill these gaps, if the right and left portions of the cushion member remain soft, and an occupant unintentionally inserts a plate-like or a rod-like material into the gap, the insertion of this material into the gap is not blocked by a soft portion of the cushion member and the material may enter the gap, with the result that the back board may possibly come off. In contrast, according to our proposed configuration, the insertion of the material into the gap can be prevented because the side portion constituent portions which are compressed and hardened fill these gaps; therefore, it is possible to prevent the back board from coming off due to the object being inserted into a space formed between the support member and each of the right and left end portions of the back board.

In the above configuration, it is preferable that the compressing member comprises the back board and a skin member configured to cover the cushion member, and that the side portion constituent portions of the cushion member are compressed by being held between the skin member and the support member, and further compressed by the back board via the skin member.

If the side portion constituent portions of the cushion member are compressed only by the back board, there may be a concern that the amount of compression of the side portion constituent portions does not become so large. In contrast, according to our proposed configuration, since the side portion constituent portions are compressed by the skin member and the back board, the amount of compression of the side portion constituent portions can be increased and the side portion constituent portions can be further hardened.

Further, if the side portion constituent portions of the cushion member are compressed only by the back board, it is necessary that the cushion member be compressed largely by the back board; therefore, there may be a concern that the attachment of the back board would become difficult because the back board receives a large repulsive force from the cushion member at the time of attachment of the back board. In contrast, with our proposed configuration in which the cushion member is compressed first by the skin member and then by the back board, the amount of compression of the cushion member at the time of attachment of the back board can be reduced, so that the attachment work of the back board can be eased.

In the above configuration, it is preferable that a rod-like member configured to support the cushion member on an inner side of the cushion member is provided between the support member and each of the right and left end portions of the back board.

It is noted that a configuration in which an object hardly enters a gap formed between the support member and the back board is more desirable than the configuration in which gaps formed between the support member and the right and left end portions of the back board are filled only by the side portion constituent portions of the cushion member. According to our proposed configuration, since a rod-like member configured to support the cushion member on an inner side of the cushion member is provided between the support member and each of the right and left end portions of the back board, thanks to the rod-like member, an object is much less likely to enter the gap formed between the support member and each of the right and left end portions of the back board.

In the above configuration, it is preferable that in a space between the support member and at least one of the right and left end portions of the back board, the rod-like member and a side portion constituent portion of the cushion member are arranged one above another.

For example, if the right and left portions of the cushion member are entirely compressed by the back board, there may be a concern that the attachment of the back board becomes difficult because the back board receives a large reaction force from the cushion member at the time of attachment of the back board. In contrast, according to our proposed configuration, since the rod-like member and the side portion constituent portion are arranged one above another in the space between the support member and at least one of the right and left end portions of the back board, it is necessary that the side portion constituent portion of the cushion member be arranged only at a position in which the rod-like member is not disposed; this makes it possible to reduce the reaction force from the cushion member at the time of attachment of the back board, so that the attachment work of the back board can be eased.

In the above configuration, it is preferable that the support member comprises main side frames constituting right and left middle portions of a seat back frame, and lower side frames fixed to lower portions of the main side frames, each lower side frame having a width greater than that of an upper portion of a corresponding main side frame, and that the side portion constituent portion of the cushion member is supported by the lower side frame.

If the side portion constituent portion having been compressed and hardened is supported by the narrow upper portion of the main side frame, there may be a concern that the cushion member would be shifted excessively because the side portion constituent portion is not stably supported. In contrast, according to our proposed configuration, since the side portion constituent portion is supported by the widened lower side frame, the side portion constituent portion is stably supported to further prevent the cushion member from being shifted excessively.

In the above configuration, it is preferable that the rod-like member is fixed at a position above a position in which the main side frame and the lower side frame are fixed.

For example, if the rod-like member is fixed at the same position in the upper-lower direction as the fixing position in which the main side frame and the lower side frame are fixed (i.e., overlapped as viewed from side), there may be a concern that the rod-like member would become an obstacle when the main side frame and the lower side frame are fixed together. In contrast, according to our proposed configuration, since the rod-like member is fixed at a position above the fixing position in which the main side frame and the lower side frame are fixed, it is possible to prevent the rod-like member from becoming an obstacle when the main side frame and the lower side frame are fixed together.

Further, in the above configuration, it is preferable that a rear surface of the cushion member has stepped portions configured to conform to upper portions of both right and left end edges of the back board.

In this configuration, it is preferable that each of the stepped portions consists of a plurality of portions including an inner portion which is located laterally inward and constitutes a lower part of the stepped portion; the both right and left end edges of the back board are located at the inner portions.

It is further preferable that the cushion member is received between the rod-like member and each of the right and left end portions of the back board.

For example, if the stepped portions as described above are not formed on the rear surface of the cushion member, there may be a concern that when the back board is fitted onto the rear surface of the cushion member, the boundary between the rear surface of the cushion member (more specifically, the skin member) and the rear surface of the back board becomes uneven, leading to poor external appearance. In contrast, according to our proposed configuration, since the stepped portions configured as described above are provided at the rear surface of the cushion member, the rear surface of the cushion member (more specifically, the skin member) and the rear surface of the back board are substantially flush with each other to improve the external appearance thereof.

Further, as the cushion member is received between the rod-like member and each of the right and left end portions of the back board, it is possible to further prevent entry of foreign objects.

In the above configuration, it is preferable that each of the stepped portions consists of a plurality of portions including an inner portion which is located laterally inward and constitutes a lower part of the stepped portion, the inner portion being provided in a region corresponding to a region in which the rod-like member is provided, that the side portion constituent portion of the cushion member is configured to be higher than the inner portion, and that a rear surface of the inner portion and a rear surface of the side portion constituent portion are connected by a gently sloped surface.

For example, if a stepped portion is formed at the boundary between the inner portion of the stepped portion and the corresponding side portion constituent portion, a gap may be formed around the boundary between the inner portion and the side portion constituent portion when the lower portion of the back board is pressed to compress the side portion constituent portion of the cushion member, and a force may not be applied evenly to the side portion constituent portion of the cushion member. In contrast, according to our proposed configuration, since the rear surface of the inner portion and the rear surface of the corresponding side portion constituent portion are connected by the gently sloped surface, it is possible to prevent a gap from being formed around the boundary between the inner portion and the side portion constituent portion when the lower portion of the back board is pressed to compress the side portion constituent portion of the cushion member; therefore, a force can be applied substantially evenly to the side portion constituent portion of the cushion member to excellently compress the side portion constituent portion.

Further, in the above configuration, it is preferable that the side portion constituent portions of the cushion member are compressed by the compressing member to an amount not less than 40 mm.

For example, if the side portion constituent portions are compressed for a very small compression amount, the side portion constituent portions are not hardened so much and there may be a concern that the cushion member is shifted excessively. In contrast, according to our proposed configuration, since the side portion constituent portions are compressed to an amount not less than 40 mm, it is ensured that the side portion constituent portions of the cushion member are hardened, to thereby excellently prevent the cushion member from being shifted excessively.

Other features and advantages of the present invention will be apparent from the following description taken in conjunction with the accompanying drawings.

### BRIEF DESCRIPTION OF DRAWINGS

FIG. 1 is a perspective view of a car seat as a vehicle seat according to one embodiment.

FIG. 2 is a perspective view of a seat frame embedded in the car seat.

FIG. 3 includes a perspective view (a) of a seat back pad as viewed from the rear side, a partial view (b) of the seat back pad as viewed from the direction indicated by arrow I, and a sectional view (c) taken along the line II-II of FIG. 3(b).

FIG. 4 is a perspective view of the car seat as viewed from the rear side.

FIG. 5 are sectional views of a rear left-side portion of a seat back, in which (a) is a sectional view taken in the vicinity of a stepped portion of the seat back pad, and (b) is a sectional view taken in the vicinity of a side portion constituent portion.

FIG. 6 is a side view showing a rod-like member.

FIG. 7 is an exploded perspective view of a back board.

FIG. 8 is an enlarged perspective view showing a lower portion of an inner board.

FIG. 9 includes an enlarged perspective view (a) of a structure around temporary joint holes for a connecting beam as viewed from the rear side, a sectional view (b) showing a state in which a temporary joint portion is engaged with a temporary joint hole, a top view (c) of the temporary joint hole as viewed from above, and a sectional view (d) showing a state in which a fixing portion is fixed to a fixing hole.

FIG. 10 is an enlarged perspective view showing a structure of a plate-like hook.

FIG. 11 includes (a) a side view, (b) a top view, and (c) a front view, showing a state in which the plate-like hook is engaged with an engagement metal part.

### DESCRIPTION OF EMBODIMENTS

One embodiment of the present invention will be described in detail with reference to the accompanying drawings where necessary. In the following description, the entire structure of a car seat as an example of a vehicle seat will be briefly described first, and then characterizing features of the present invention will be described in detail.

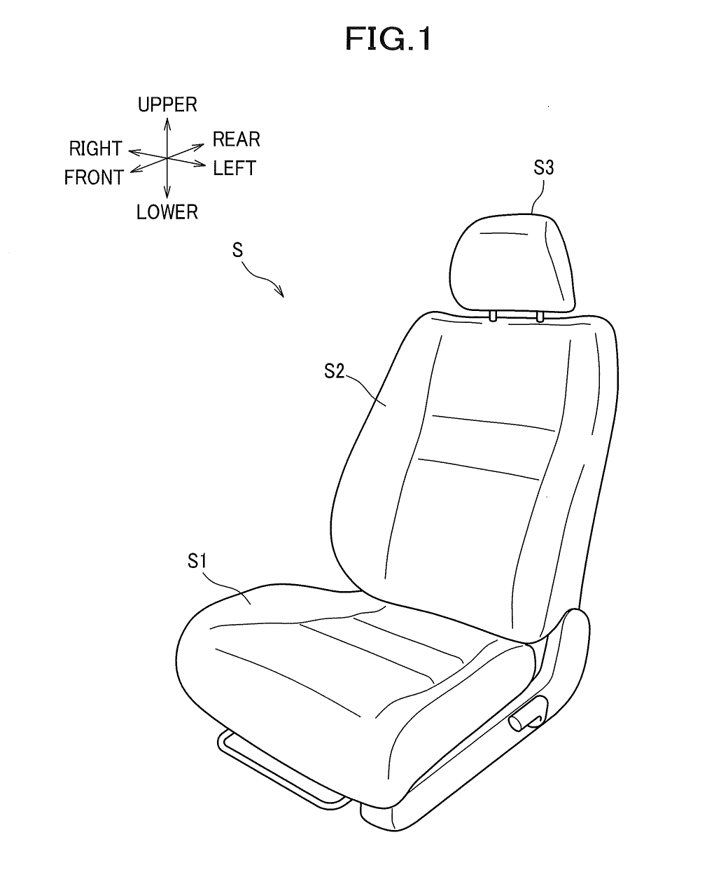

As seen in FIG. 1, the car seat S is a seat for use as a driver's seat of a car, and mainly includes a seat cushion S1, a seat back S2, and a headrest S3.

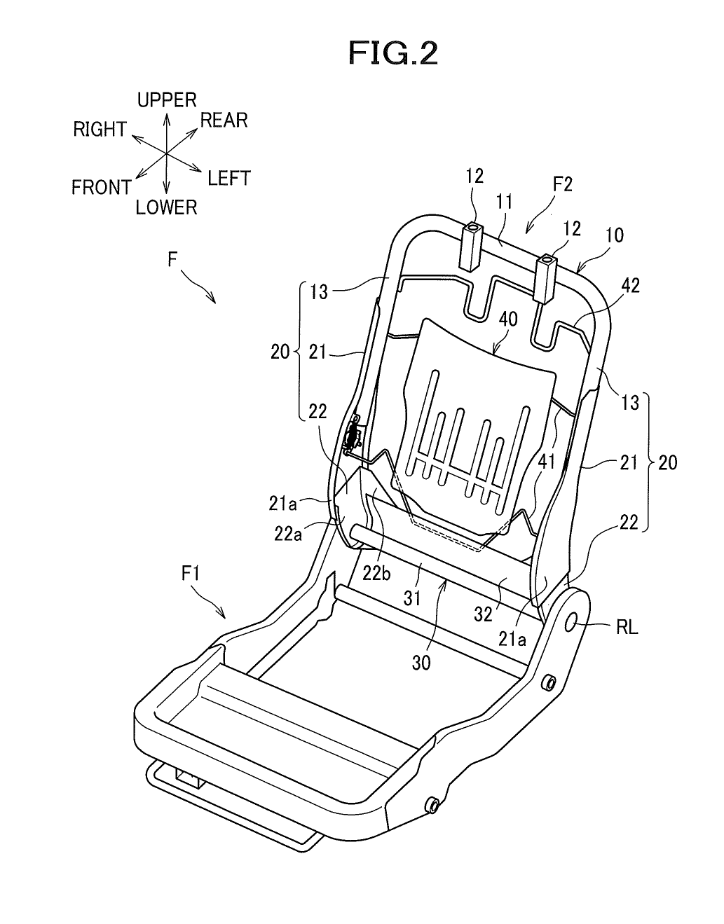

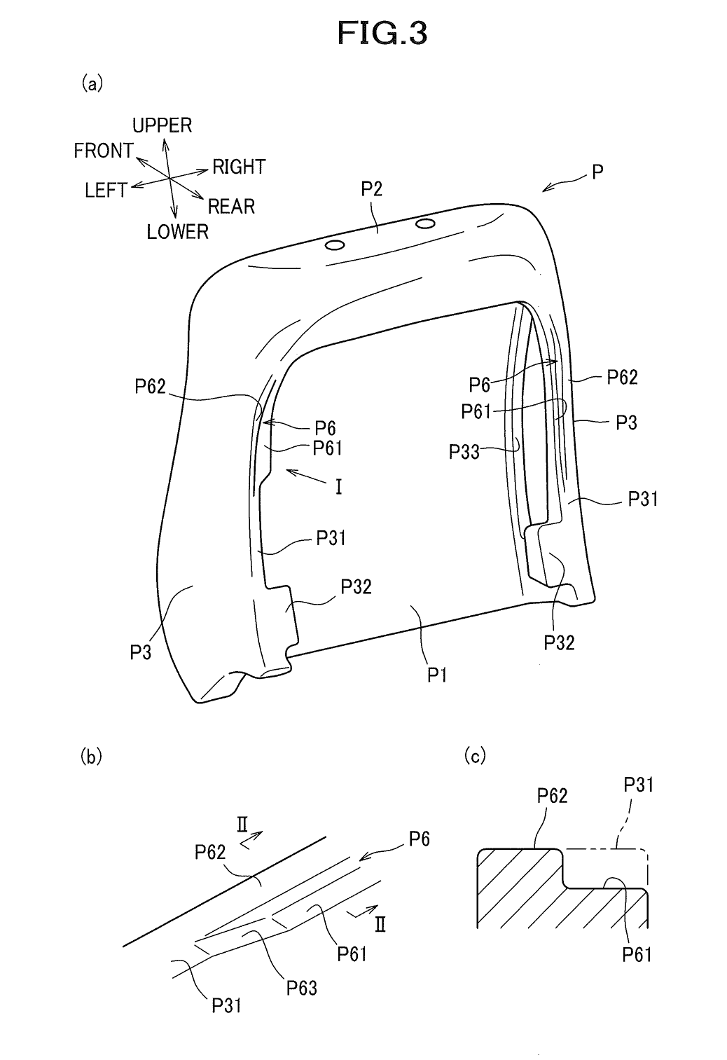

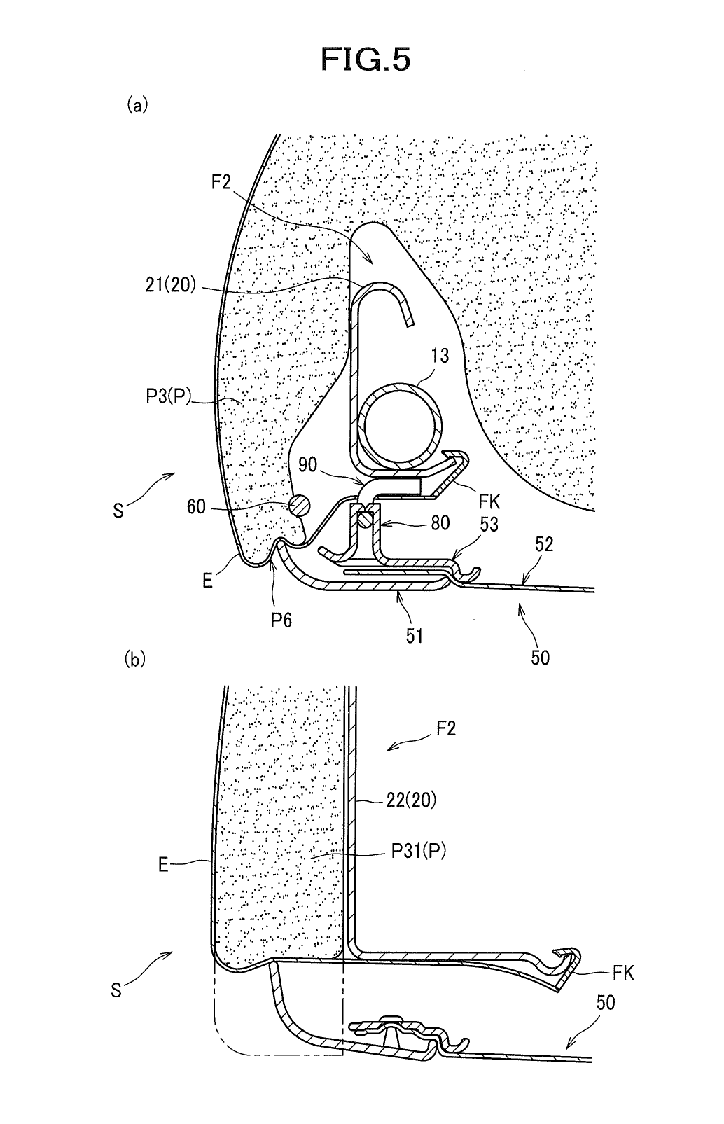

A seat frame F as shown in FIG. 2 is embedded in the seat cushion S1 and the seat back S2. The seat frame F mainly includes a seat cushion frame F1 constituting a frame of the seat cushion S1, and a seat back frame F2 constituting a frame of the seat back S2. The seat cushion S1 is configured such that the seat cushion frame F1 is covered with a seat cushion pad made of a cushion material such as urethane foam, and a skin member made of synthetic leather or fabric. The seat back S2 is configured such that the seat back frame F2 is covered with a seat back pad P (see FIG. 3) made of a cushion material, and a skin member E (see FIG. 5) made of synthetic leather or fabric.

The seat back frame F2 has a lower portion which is rotatably connected to a rear portion of the seat cushion frame F1 via a reclining mechanism RL. Accordingly, the seat back S2 is tiltable in the front-rear directions relative to the seat cushion S1.

In this description, the front/back (frontward/rearward), right/left (lateral), and upper/lower directions are designated as from the view point of an occupant seated on the car seat S of which the seat back S2 is not tilted down by the reclining mechanism RL.

The seat back frame F2 mainly consists of an upper frame 10, right and left side frames 20 as an example of a support member, and a lower frame 30; the upper frame 10, the right and left side frames 20, and the lower frame 30 are joined together, for example, by welding to thereby form a frame-like configuration. A pressure-receiving member 40 configured to receive a load from the occupant and wires 41 are arranged inside the frame-like seat back frame F2.

The upper frame 10 is formed by bending a pipe material into a substantially U-shape configuration and includes a lateral pipe portion 11 extending in the right-left direction, and a pair of right and left support brackets 12 for attachment of the headrest S3 are fixed by welding to the front side of the lateral pipe portion 11. Right and left vertical pipe portions 13 of the upper frame 10 extend in the upper-lower direction; right and left main side frames 21 are joined to lower portions of the vertical pipe portions 13 and made into integral parts to thereby form right and left side frames 20.

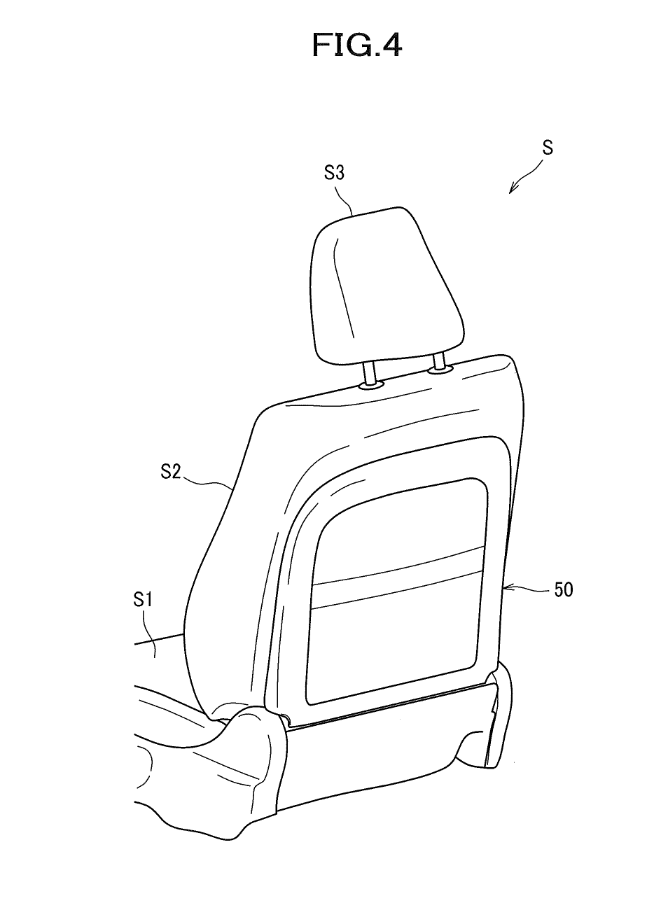

It is to be noted that a rigid wire 42 with which an upper portion of a back board 50 to be described later (see FIG. 4) is engaged is provided at upper portions of the right and left vertical pipe portions 13; the rigid wire 42 is bent at proper positions and extends in the right-left directions.

Each side frame 20 includes the right or left vertical pipe portion 13 as described above, the right or left main side frame 21, and a lower side frame 22.

Each of the right and left main side frames 21 constitutes a middle portion of the side frame 20, and is made by press working sheet metal to have a substantially U-shaped cross section; the right and left main side frames 21 are arranged laterally opposite to each other. The main side frame 21 is connected to the vertical pipe portion 13 with its upper portion holding the vertical pipe portion 13, and the lower portion of the main side frame 21 protrudes frontward farther than the upper portion of the main side frame 21 to form a bulging portion 21a.

Each of the right and left lower side frames 22 constitutes a lower portion of the side frame 20, and is made by press working sheet metal to have a substantially U-shaped cross section; the right and left lower side frames 22 are arranged laterally opposite to each other. The lower side frame 22 is connected to the lower portion of the main side frame 21 by welding with its upper portion being held by the lower portion of the main side frame 21.

To be more specific, the lower side frame 22 has a width in the front-rear direction which is the same as that of the lower portion of the main side frame 21. In other words, the lower side frame 22 has a width in the front-rear direction which is wider than that of the narrower upper portion of the main side frame 21.

The lower frame 30 includes a connecting pipe 31 configured to connect right and left lower side frames 22, and a connecting beam 32. To be more specific, the connecting pipe 31 connects side walls 22a each corresponding to a bottom portion of the lower side frame 22 having a substantially U-shaped cross section, and the connecting beam 32 connects flange portions 22b each extending laterally inward from the rear end and the lower end of the side wall 22a of the lower side frame 22.

As seen in FIG. 3(a), the seat back pad P is a member for supporting the back of the occupant; the seat back pad P is put over the above-described seat back frame F2 from the front side and thereby supported by the seat back frame F2. To be more specific, the seat back pad P includes a front wall portion P1 for supporting the back of the occupant, an upper wall portion P2 configured to protrude rearward from the upper end portion of the front wall portion P1, and right and left side wall portions P3 configured to protrude rearward from the right and left end portions of the front wall portion P1.

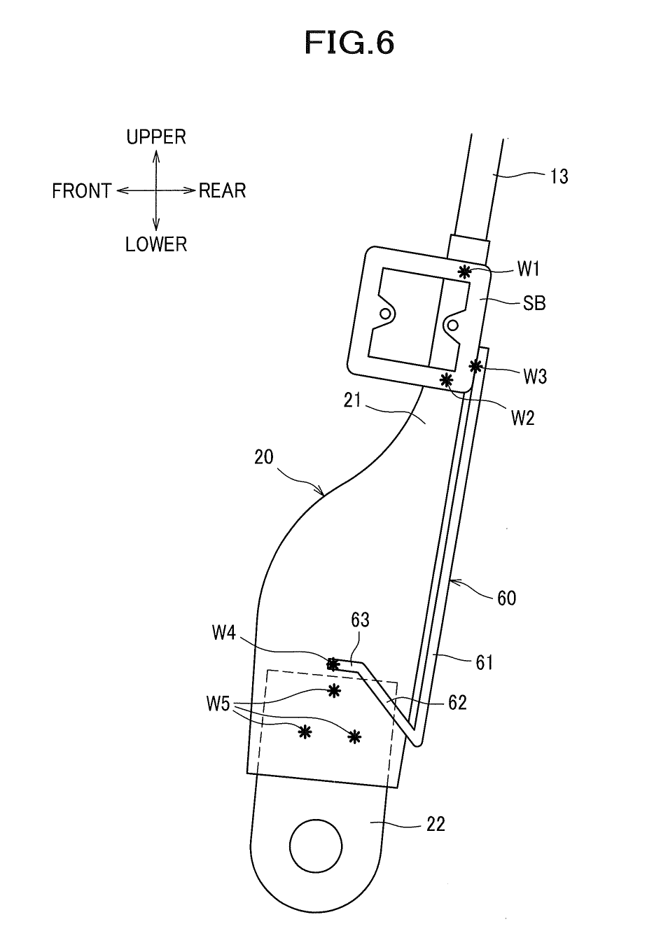

A stepped portion P6, a side portion constituent portion P31, and a protruding portion P32 are provided at the rear portion of each of the side wall portions P3. The stepped portion P6 is provided at an upper side of the rear portion of each of the right and left side wall portions P3; as seen in FIGS. 3(b) and 3(c), inner portions P61 that are located laterally inward are lower in height than outer portions P62 that are located laterally outward. Further, both right and left end edges of the back board 50 to be described later are arranged such that they are pressed from the rear side against the right and left inner portions P61; accordingly, each of the inner portions P61 slightly enters a space between a rod-like member 60 and each of the right and left end portions of the back board 50. Since the inner portion P61 enters the space between the rod-like member 60 and each of the right and left end portions of the back board 50, a sealing property is improved between the right and left end portions of the back board 50 and the inner portions P61, to thereby prevent foreign objects from entering the space inside the seat back pad P. It is to be noted that the inner portions P61 are provided at regions corresponding to where the rod-like members 60 to be described later (see FIG. 6) are provided.

As seen in FIG. 4, these stepped portions P6 are shaped to match the contour of the upper portions of the both right and left end edges of the back board 50 that is arranged at the rear side of the seat back frame F2. To be more specific, the stepped portions P6 of the seat back pad P have shapes to match the upper portions of the both right and left end edges of the back board 50 with the skin member E being sandwiched between the stepped portions P6 and the back board 50.

Accordingly, as seen in FIG. 5(a), the rear surface of the seat back pad P (more specifically, the skin member E) and the rear surface of the back board 50 are substantially flush with each other to improve the external appearance thereof, for example, as compared to the configuration in which the stepped portions P6 are not provided.

Returning to FIG. 3(a), the side portion constituent portions P31 are configured to be compressed to a larger extent than the other portions by the skin member E and the back board 50 which are examples of a compressing member to be described later; the side portion constituent portions P31 are arranged underneath the stepped portions P6. As seen in FIGS. 3(b) and 3(c), each of the side portion constituent portions P31 is shaped to be higher than the inner portion P61 of the stepped portion P6, and the rear surface of the inner portion P61 and the rear surface of the side portion constituent portion P31 are connected by a gently sloped surface P63.

Accordingly, it is possible to prevent a gap from being formed around the boundary between the inner portion P61 and the side portion constituent portion P31 when the lower portion of the back board 50 is pressed forward to compress the side portion constituent portions P31; therefore, a force can be applied substantially evenly to the side portion constituent portions P31 to excellently compress the side portion constituent portions P31.

As seen in FIG. 3(a), the protruding portions P32 are arranged underneath the side portion constituent portions P31 and formed to inwardly protrude from the side wall portions P3. Further, a through-opening P33 is formed to penetrate through the right side wall portion P3 in the right-left direction.

As seen in FIGS. 5(a) and 5(b), the outer side of the seat back pad P configured as describe above is covered with the skin member E. The skin member E wraps around the seat back pad P from the front side thereof and goes around to the rear side thereof, and is fixed to the seat back frame F2 using hooks FK provided at the end portions of the skin member E.

As shown by the phantom line of FIG. 5(b), since the side portion constituent portions P31 are configured to protrude rearward relative to the side frames 20 to a larger extent than the other portions, the side portion constituent portions P31 are largely compressed by the skin member E upon attachment of the skin member E. Therefore, since the side portion constituent portions P31 are compressed and hardened by the skin member E, it is possible to prevent the seat back pad P from being shifted excessively to the right and to the left.

Further, in this embodiment, when the back board 50 is attached to the seat back frame F2 from the rear side thereof after attachment of the skin member E, the side portion constituent portions P31 are further compressed by the right and left end portions of the back board 50. Since the side portion constituent portions P31 are compressed by both the skin member E and the back board 50, the amount of compression of the side portion constituent portions P31 can be increased to further harden the side portion constituent portions P31.

It is preferable that the side portion constituent portions P31 are compressed by the skin member E and the back board 50 to an amount not less than 40 mm. Since the side portion constituent portions P31 are compressed to an amount not less than 40 mm, it is ensured that the side portion constituent portions P31 are hardened, to thereby excellently prevent the seat back pad P from being shifted excessively.

In this embodiment, in a pre-compression state in which the side portion constituent portions P31 are not compressed, the side portion constituent portions P31 protrude rearward beyond the rear surfaces of the lower side frames 22. In this configuration, if the side portion constituent portions P31 are compressed by more than half of the amount of protrusion from the rear surfaces of the lower side frames 22 in the pre-compression state, a sufficient hardness of the side portion constituent portions P31 can be obtained. It is further preferable that the side portion constituent portions P31 are compressed to the rear surfaces of the lower side frames 22.

As described above, since the side portion constituent portions P31 are compressed first by the skin member E and then by the back board 50, the amount of compression of the side portion constituent portions P31 at the time of attachment of the back board 50 can be reduced, so that the attachment work of the back board 50 can be eased.

Further, the side portion constituent portions P31 are supported from laterally inner sides thereof by the lower side frames 22 which are wider than the upper portions of the main side frames 21. Therefore, since the side portion constituent portions P31 can be stably supported by the widened lower side frames 22, it is possible to further prevent the seat back pad P from being shifted excessively.

The back board 50 is arranged such that a gap is formed between each of the right and left end portions of the back board 50 and the side frame 20. Further, the side portion constituent portions P31 are arranged such that the gap formed between each of the right and left end portions of the back board 50 and the side frame 20 is filled therewith. Therefore, insertion of a material into the gap can be prevented because the side portion constituent portions P31 which are compressed and hardened fill these gaps; therefore, it is possible to prevent the back board 50 from coming off due to the object being inserted into the gaps formed between the right and left end portions of the back board 50 and the side frames 20.

Especially, in this embodiment, the side portion constituent portions P31 are arranged at lower parts of the spaces (gaps) formed between the right and left end portions of the back board 50 and the side frames 20, and as seen in FIGS. 5(a) and 6, at the upper parts of the spaces (gaps) higher than the side portion constituent portions P31 are provided the rod-like members 60 for supporting the seat back pad P from inner sides thereof. Therefore, the side portion constituent portions P31 that are to be compressed largely are arranged only in part of the gaps; this makes it possible to reduce the reaction force from the side portion constituent portions P31 at the time of attachment of the skin member E and the back board 50, so that the attachment work of the back board 50 can be eased.

More specifically, each rod-like member 60 includes a main body portion 61 elongated along the side frame 20, a first extension portion 62 extending in an obliquely frontward and upward direction from the lower end portion of the main body portion 61, and a second extension portion 63 extending in a substantially frontward direction from the front end of the first extension portion 62. Further, the upper end portion of the main body portion 61 is joined by welding to a switch bracket SB that is joined to the upper end portion of the main side frame 21 by welding.

To be more specific, the switch bracket SB is welded to the upper end portion of the main side frame 21 at two (upper and lower) welds W1, W2, and the upper end portion of the main body portion 61 is welded to the switch bracket SB at a weld W3 that is located between the two welds W1, W2. This configuration can enhance the mounting rigidity of the switch bracket SB. The switch bracket SB is a bracket for use in mounting a reclining switch and a sliding switch of the car seat S.

The end portion of the second extension portion 63 is joined to the lower part of the main side frame 21 by welding. To be more specific, the weld W4 (fixing position) for fixing the second extension portion 63 is located above three welds W5 (fixing positions) in which the main side frame 21 is fixed to the lower side frame 22.

With this configuration, it is possible to prevent the rod-like member 60 from becoming an obstacle when the main side frame 21 and the lower side frame 22 are fixed together by welding. Further, since the first extension portion 62 extends obliquely in a rearward and downward direction relative to the weld W4, the length of the main body portion 61 can be increased in the upper-lower direction, and according to this increased length, the size of the side portion constituent portion P31 arranged at the lower part of the main body portion 61 can be decreased, so that a repulsive force at the time of attachment of the skin member E and the like can be reduced.

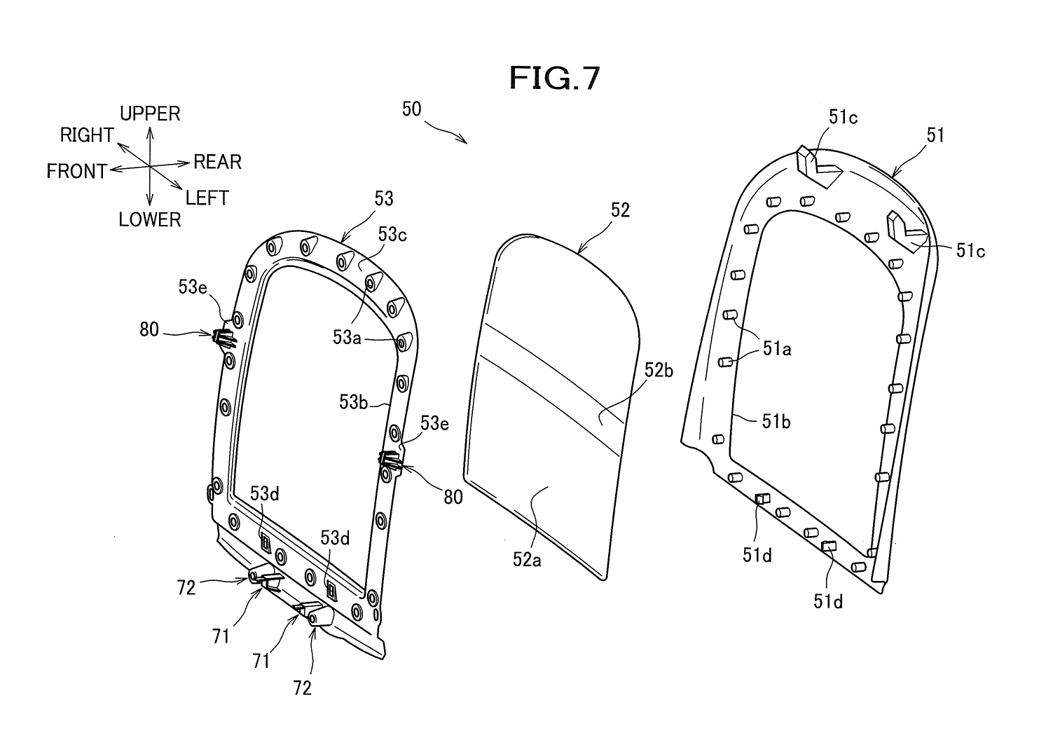

As seen in FIG. 7, the back board 50 includes an outer board 51 made of a plastic resin, a pocket member 52 made of a synthetic leather or fabric, and an inner board 53 made of a plastic resin.

The outer board 51 is shaped like a substantially rectangular frame, and includes an opening 51b and a plurality of welding bosses 51a provided at the front side of the outer board 51 to protrude frontward and surrounding the opening 51b. The welding bosses 51a are inserted into corresponding welding holes 53a provided in the inner board 53 while the pocket member 52 is sandwiched between the outer board 51 and the inner board 53, and then the welding bosses 51a are fused, so that the outer board 51 and the inner board 53 retains the pocket member 52 between them.

Provided at the front lower portion of the outer board 51 are a pair of right and left hook-shaped claw portions 51d which are spaced apart laterally and protrude frontward and then laterally inward in the right-left direction. The claw portions 51d are claws engageable with a pair of right and left engagement holes 53d formed in the lower portion of the inner board 53; by these claw portions 51d and the engagement holes 53d, the outer board 51 and the inner board 53 can be temporarily assembled together.

Provided at the front upper portion of the outer board 51 are a pair of right and left hook-shaped portions 51c which protrude frontward and then upward. The hook-shaped portions 51c are configured such that when the outer board 51 and the inner board 53 are welded together, they are located above the inner board 53; the hook-shaped portions 51c are engageable with the rigid wire 42 shown in FIG. 2 from the lower side thereof at the time of attachment of the back board 50 to the seat back frame F2.

Accordingly, the outer board 51 can be roughly positioned in the upper-lower direction and its upper portion can be prevented from falling backward.

The pocket member 52 comprises a plurality of layered skin members each made of a synthetic leather or fabric, so that a pocket portion 52a for storage of items can be formed; the inlet portion 52b of the pocket portion 52a includes a plate-like member provided between the layered skin members for the purpose of improving the usability of the pocket portion 52a. For this purpose, the inlet portion 52b forms a thickened portion that is the thickest portion of the pocket member 52.

The inner board 53 is shaped like a substantially rectangular frame, and the plurality of welding holes 53a corresponding to the plurality of welding bosses 51a of the outer board 51 are provided to surround an opening 53b. To be more specific, the plurality of welding holes 53a are arranged at positions along the outer peripheral edges of the frame-like main body portion 53c (inwardly of protruding tabs 53e to be described later).

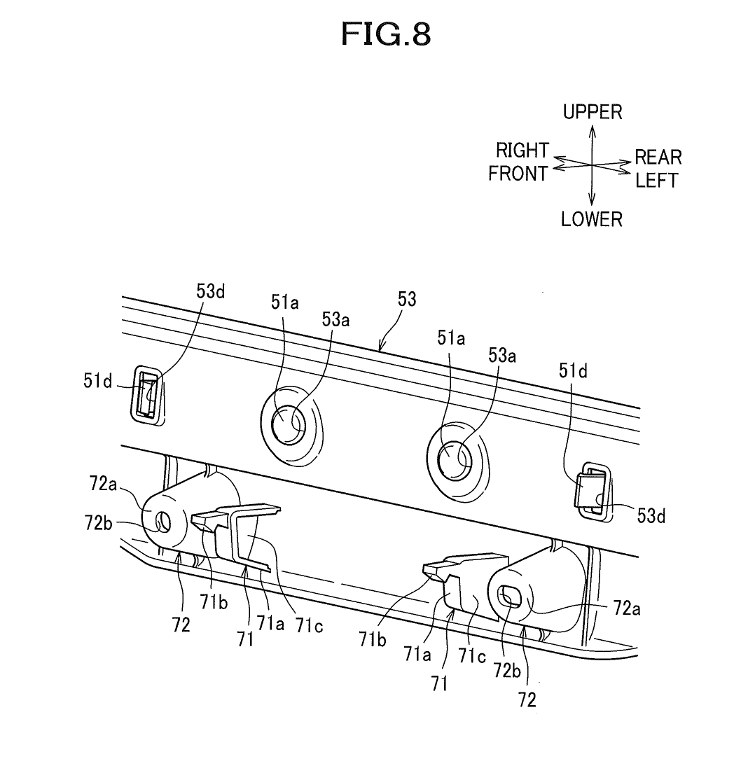

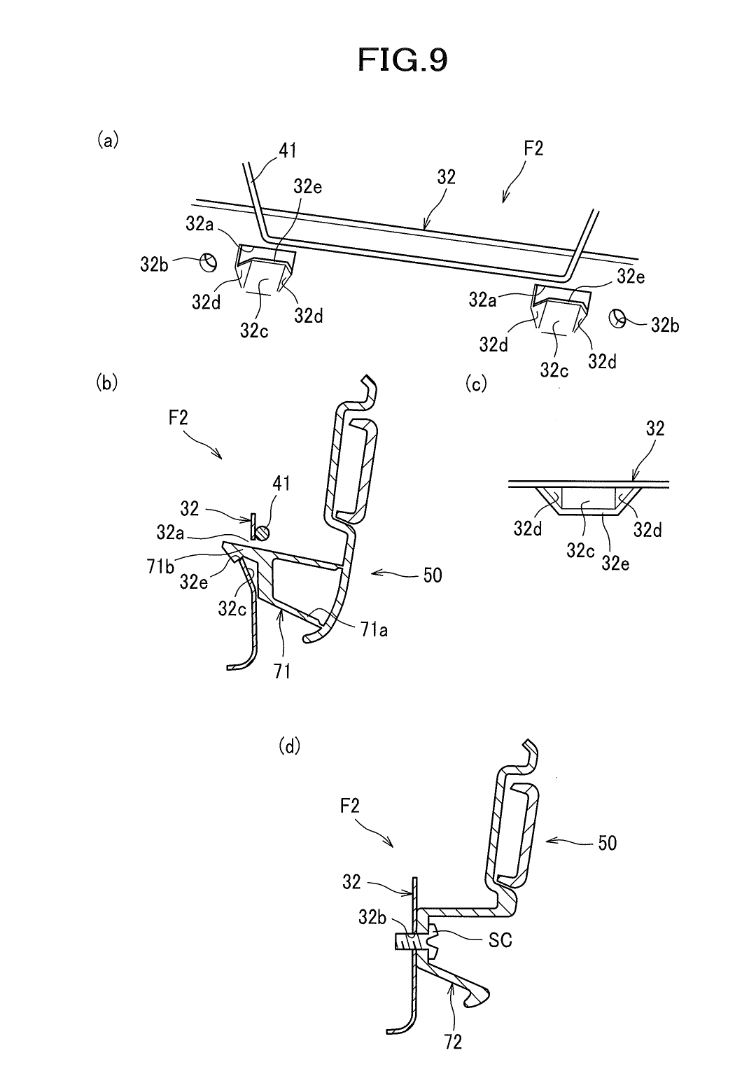

Provided at the lower portion of the inner board 53 are the pair of engagement holes 53d described above, and as seen in FIGS. 8 and 9, right and left temporary joint portions 71 and right and left fixing portions 72 are provided in pair at the lower side of the pair of engagement holes 53d; the temporary joint portions 71 are configured to be engageable with the connecting beam 32 of the seat back frame F2 so that they are retained by the connecting beam 32, and the fixing portions 72 are configured to be fixed to the connecting beam 32. The left temporary joint portion 71 is laterally adjacent to the left fixing portion 72, and the right temporary joint portion 71 is laterally adjacent to the right fixing portion 72.

As the temporary joint portions 71 and the fixing portions 72 are adjacent to each other as described above, they are less likely to be affected by the manufacturing error; therefore, even if fixing positions (fixing holes 32b to be described later) of the fixing portions 72 and the connecting beam 32 are misaligned due to the manufacturing error, the amount of misalignment is very small after the temporary joint portions 71 are engaged with the connecting beam 32 at predetermined engagement portions (i.e., temporary joint holes 32a to be described later). Accordingly, it is possible to ease the positioning work for positioning the fixing portions 72 to the fixing positions.

Further, since the temporary joint portions 71 and the fixing portions 72 are laterally adjacent to each other, the sizes of the back board 50 and the connecting beam 32 as assembled can be decreased in the upper-lower direction, for example, as compared to the configuration in which each of the temporary joint portions and each of the fixing portions are vertically adjacent to each other; this can result in weight reduction.

In terms of another aspect of the layout of the right and left temporary joint portions 71 and the fixing portions 72 as described above, one temporary joint portion 71 and one fixing portion 72 which are laterally adjacent to each other are provided in pair, and two pairs of these portions 71, 72 are laterally spaced apart from each other. In each of these pairs, the fixing portion 72 is located laterally outward of the adjacent temporary joint portion 71.

With this configuration, the distance between each of the right and left end portions of the back board 50 and the corresponding fixing portion 72 can be decreased, for example, as compared to the configuration in which the fixing portions are arranged laterally inward of the temporary joint portions; therefore, the moment applied to the fixing portion 72 when the right or the left end portion of the back board 50 fixed to the connecting beam 32 is tugged can be lessened, so that the attachment rigidity of the back board 50 to the connecting beam 32 can be enhanced.

More specifically, each temporary joint portion 71 includes a base portion 71a which protrudes frontward from the back board 50, and an engagement portion 71b which protrudes frontward from the base portion 71a and configured to be engageable with a corresponding temporary joint hole 32a of the connecting beam 32. The base portion 71a is shaped like a tube having a bottom, which opens laterally inward toward the opposite side that is away from the adjacent fixing portion 72.

Since the base portion 71a is shaped like a tube having a bottom (hollow shape), the weight of the back board 50 can be reduced, for example, as compared to the configuration in which the base portion is solid. Further, since the bottomed tubular-shaped base portion 71a opens toward the opposite direction away from the fixing portion 72, a wall 71c corresponding to the bottom of the bottomed tubular-shaped base portion 71a is adjacent to the fixing portion 72, so that the rigidity of the fixing portion 72 can be enhanced.

The engagement portion 71b is shaped like a hook which protrudes frontward and then downward, and the lateral width of the front end of the engagement portion 71b is smaller than the lateral width of the temporary joint hole 32a.

The fixing portion 72 protrudes frontward from the back board 50 and is shaped like a rearwardly opening tube having a bottom. The fixing portion 72 tapers toward the front, so that the rigidity of the fixing portion 72 per se can be enhanced.

Further, a through-hole 72b is formed in a wall 72a that is the bottom of the bottomed tubular fixing portion 72; the through-hole 72b is used for inserting a screw SC by which the fixing portion 72 is fixed to the connecting beam 32. The through-hole 72b formed in the right fixing portion 72 is formed as an oblong hole extending in the upper-lower direction, and the through-hole 72b formed in the left fixing portion 72 is formed as an oblong hole extending in the right-left direction. With this configuration, even if the back board 50 made of a plastic resin thermally expands in the upper-lower and right-left directions, the through-holes 72b can limit the influence of the thermal expansion.

As seen in FIG. 9(a), the connecting beam 32 includes a pair of right and left temporary joint holes 32a with which the distal ends of the engagement portions 71b of the pair of right and left temporary joint portions 71 are engageable, and a pair of right and left fixing holes 32b arranged laterally outward of the pair of right and left temporary joint holes 32a. Provided under each of the temporary joint holes 32a is a first slanted surface 32c for guiding the distal end of the engagement portion 71b of the temporary joint portion 71 toward the temporary joint hole 32a from lower side to upper side.

Accordingly, since the first slanted surface 32c can guide the distal end of the engagement portion 71b of the temporary joint portion 71 in the upper-lower direction toward the temporary joint hole 32a, it is possible to ease the attachment work of the back board 50.

Further, a pair of second slanted surfaces 32d are provided at right and left sides of the first slanted surface 32c; the second slanted surfaces 32d are configured to guide the distal end of the engagement portion 71b of the temporary joint portion 71 in a laterally inward direction. Accordingly, since the engagement portion 71b of the temporary joint portion 71 can be guided toward the first slanted surface 32c, it is possible to ease the attachment work of the back board.

The first slanted surface 32c and the second slanted surfaces 32d provided at both right and left sides of the first slanted surface 32c are integrally formed as a recess portion, and the distal end of the engagement portion 71b of the temporary joint portion 71 is engageable with the upper edge portion 32e of the recess portion, which forms the lower edge of the temporary joint hole 32a. Since the first slanted surface 32c and the second slanted surfaces 32d are integrally formed as a recess portion, the distal end of the engagement portion 71b of the temporary joint portion 71 engages with the upper edge portion 32e of the recess portion having enhanced rigidity due to the recessed shape, so that the temporary joint of the back board 50 can be excellently performed.

Further, as viewed from the rear side, the temporary joint holes 32a are provided at positions not overlapping (avoiding) the wires 41 for supporting the occupant. Therefore, when the distal ends of the engagement portions 71b of the temporary joint portions 71 are engaged with the temporary joint holes 32a, it is possible to prevent the distal ends of the engagement portions 71b from interfering with the wire 41.

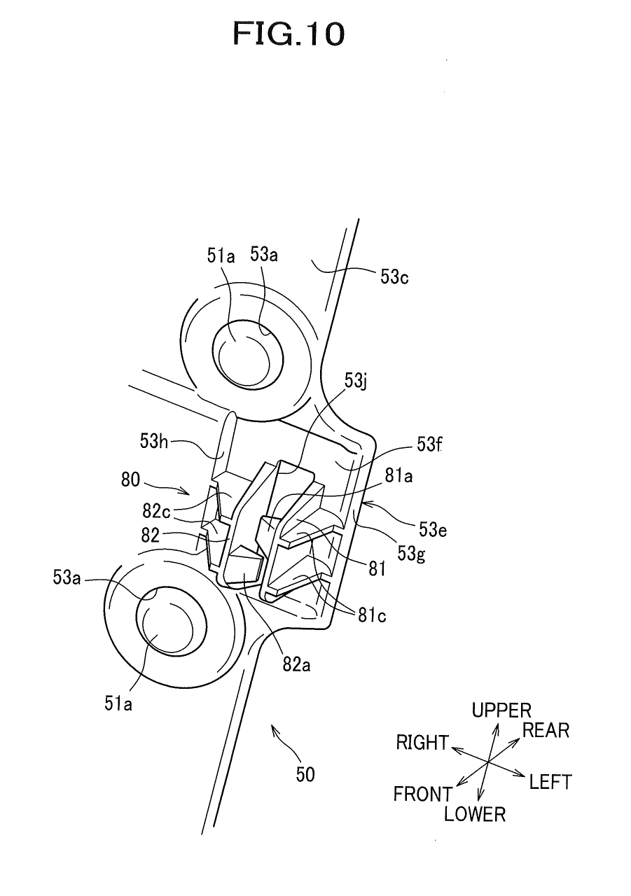

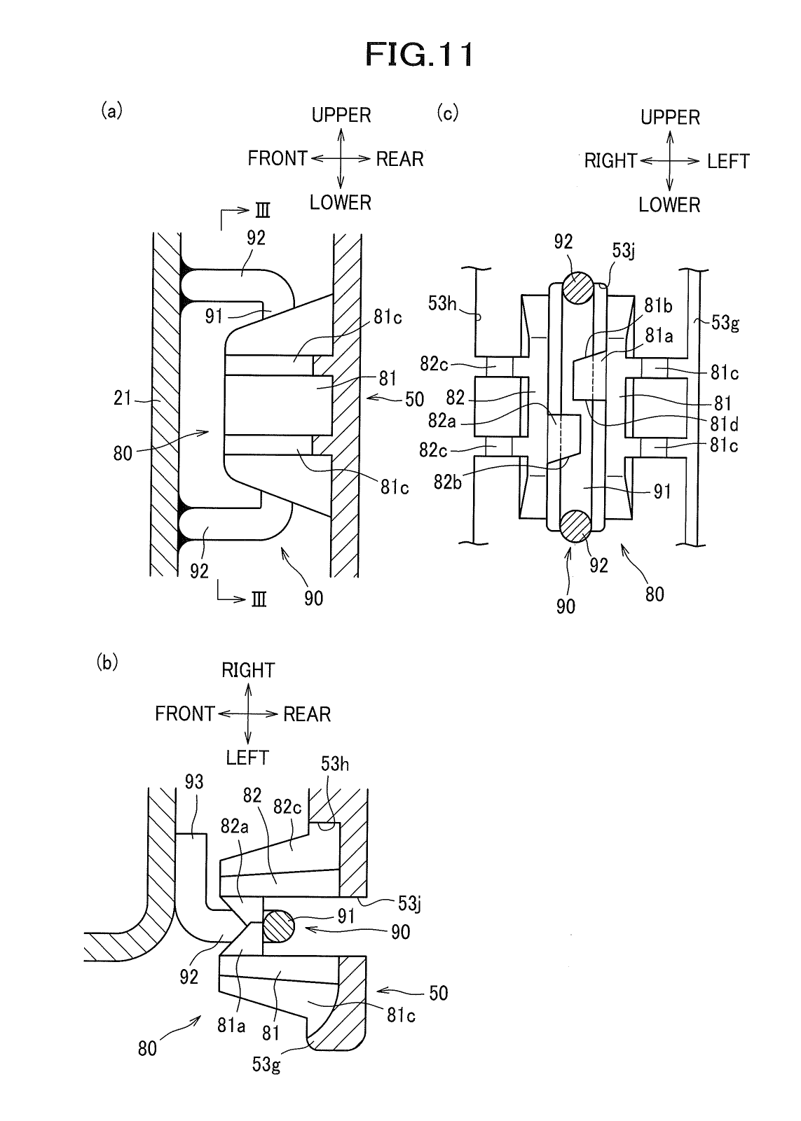

Returning to FIG. 7, protruding tabs 53e are provided substantially centrally at both right and left side portions of the main body portion 53c of the inner board 53 so as to protrude outward from the outer peripheral edges of the main body portion 53c. And as seen in FIGS. 10 and 11, a pair of plate-like hooks 80 are provided at positions adjacent to the right and left protruding tabs 53e; each of the plate-like hooks 80 is engageable with an engagement metal part 90 provided on the main side frame 21 and having a U-shaped form as viewed from side (see FIG. 11(a)).

The engagement metal part 90 is made by bending both end portions of a rod-like member having a tubular section to provide a U-shaped profile as viewed from side and thereafter bending the end portions laterally inward. To be more specific, the engagement metal part 90 includes a first rod-like portion 91 extending in the upper-lower direction, second rod-like portions 92 extending frontward from upper and lower end portions of the first rod-like portion 91, and third rod-like portions 93 extending laterally inward from the second rod-like portions 92 (see FIG. 11(b)).

Each of the plate-like hooks 80 includes a first plate-like portion 81 protruding frontward from the back board 50, and a second plate-like portion 82 protruding frontward from the back board 50 and located laterally opposite the first plate-like portion 81.

Provided at an upper portion of the front end portion of the inner surface (i.e., surface facing the second plate-like portion 82) of the first plate-like portion 81 is a first engagement portion 81a which protrudes from this upper portion toward the second plate-like portion 82. Similarly, provided at a lower portion of the front end portion of the inner surface (i.e., surface facing the first plate-like portion 81) of the second plate-like portion 82 is a second engagement portion 82a which protrudes from this lower portion toward the first plate-like portion 81.

In a state in which the plate-like hook 80 is engaged with the engagement metal part 90, the first rod-like portion 91 of the engagement metal part 90 is held between the first plate-like portion 81 and the second plate-like portion 82, and the first engagement portion 81a and the second engagement portion 82a are engaged with the first rod-like portion 91 from the front side. Since the widths of the plate-like portions 81, 82 are wider in the upper-lower direction than the widths of the corresponding engagement portions 81a, 82a, the rigidity of these plate-like portions 81, 82 can be enhanced, so that the engagement portions 81a, 82a and the first rod-like portion 91 can engage more tightly with each other.

The first plate-like portion 81 (i.e., part of the plate-like hook 80) is disposed on the protruding tab 53e which protrudes outward from the outer peripheral edge of the main body portion 53c of the inner board 53. Accordingly, the distance between each of the right and left end portions of the back board 50 and the plate-like hook 80 can be decreased, for example, as compared to the configuration in which the entire plate-like hook 80 is disposed on the main body portion 53c; therefore, the moment applied to the plate-like hook 80 when the right or the left end portion of the back board 50 is tugged can be lessened, so that the plate-like hook 80 is less likely to come off the engagement metal part 90.

The protruding tabs 53e are provided only where the plate-like hooks 80 are disposed, and the other outer peripheral edges (outer peripheral edges of the main body portion 53c) are located inward of the protruding tabs 53e; therefore, the weight of the inner board 53 can be reduced, for example, as compared to the configuration in which the outer peripheral edges of the main body portion 53c extend to the outer peripheral edges of the protruding tabs 53e.

Further, as seen in FIG. 11(c), outer surfaces 81b, 82b of the engagement portions 81a, 82a, which are located outward in the upper-lower direction, are each configured to slant so as to be positioned inward in the upper-lower direction as it goes inward in the right-left direction. Accordingly, when the plate-like hook 80 is caused to move in the upper-lower direction, the slanted surface 81b or 82b is brought into contact with the second rod-like portion 92 to thereby cause the plate-like portions 81, 82 to spread out; therefore, the engagement portions 81a, 82a can be configured to easily come off the second rod-like portions 92 in the upper-lower direction.

To be more specific, for example, when the plate-like hook 80 is moved downward, the slanted surface 82b of the second engagement portion 82a is brought into contact with the lower second rod-like portion 92, so that the second plate-like portion 82 spreads out to the right side. After that, the surface 81d orthogonal to the upper-lower direction of the first engagement portion 81a is brought into contact with the second rod-like portion 92 and the movement of the plate-like hook 80 is stopped; however, the second plate-like portion 82 can further spread out to the right side by changing the moving direction of the plate-like hook 80 to the diagonally downward-and-left direction, whereby the engagement portions 81a, 82a can be disengaged from the second rod-like portions 92.

As seen in FIG. 10, there are two ribs (ridge portions) 81c, 82c provided on each of laterally outer surfaces of the first plate-like portion 81 and the second plate-like portion 82. This can enhance the rigidity of each of the plate-like portions 81, 82.

Especially, in this embodiment, the first plate-like portion 81 and the second plate-like portion 82 are provided on the bottom surface of a recess portion 53f formed to extend over the main body portion 53c and each protruding tab 53e of the back board 50. Accordingly, a left wall 53g which protrudes frontward from the bottom surface of the recess portion 53f is formed at the left side (i.e., opposite side from the first plate-like portion 81) of the ribs 81c, and a right wall 53h which protrudes frontward from the bottom surface of the recess portion 53f is formed at the right side (i.e., opposite side from the second plate-like portion 82) of the ribs 82c.

The ribs 81c of the first plate-like portion 81 are configured to connect the laterally outer surface of the first plate-like portion 81, the bottom surface of the recess portion 53f, and the left wall 53g. Similarly, the ribs 82c of the second plate-like portion 82 are configured to connect the laterally outer plane of the second plate-like portion 82, the bottom surface of the recess portion 53f, and the right wall 53h.

With this configuration, the rigidity of each of the plate-like portions 81, 82 can be enhanced further, for example, as compared to the configuration in which the ribs are not connected to the bottom surface of the recess portion or to the right and left walls.

Further, a substantially rectangular hole 53j elongated in the upper-lower direction is formed in the back board 50 between the plate-like portions 81, 82. The hole 53j is formed such that the lateral width thereof is substantially the same as the distance between the plate-like portions 81, 82, and that the length thereof in the upper-lower direction is slightly greater than the length of the plate-like portions 81, 82 in the upper-lower direction. With this configuration, the weight of the back board 50 can be reduced.

Further, the plate-like portions 81, 82 are provided between two adjacent fixing points (welding bosses 51a and welding holes 53a). Since the plate-like portions 81, 82 are provided at a higher-rigidity area between the two adjacent fixing points, the rigidity of the plate-like portions 81, 82 can be further enhanced.

Further, at least one of the two adjacent fixing points located to sandwich the above-described plate-like portions 81, 82 is arranged in the proximity of the thickened pocket portion 52a of the pocket member 52 as shown in FIG. 7. Since the thickened pocket portion 52a of the pocket member 52 can be firmly retained by the fixing points by the aforementioned configuration in which at least one of the two adjacent fixing points located to sandwich the plate-like portions 81, 82 is arranged in the proximity of the pocket portion 52a of the pocket member 52, it is possible to render the pocket member 52 and the outer board 51 substantially flush with each other.

Although one embodiment of the present invention has been described above, the present invention can be practiced, as shown in the following embodiments, with various modifications and changes.

In the above embodiment, each rod-like member 60 is arranged in a gap between the right or the left end portion of the back board 50 and the corresponding side frame 20, at a region of the gap in which the side portion constituent portion P31 is not disposed. However, the present invention is not limited to this configuration; for example, a rod-like member may be arranged in the gap at a region in which the side portion constituent portion is disposed. With this configuration, thanks to the side portion constituent portion and the rod-like member, the risk of entry of an object into the gaps formed between the support member and the right and left end portions of the back board can be further reduced.

In the above embodiment, the side portion constituent portions P31 located laterally outward of the side frames 20 are compressed. However, the present invention is not limited to this configuration; for example, portions of the cushion member which go around to the rear side of the side frames (e.g., protruding portions P32 shown in FIG. 3(a)) may be compressed.

In the above embodiment, the seat back pad P has been taken as an example of a cushion member. However, the present invention is not limited to this configuration; for example, the cushion member may be a seat cushion pad or the like. Further, the support member is not limited to the seat back frame F2; for example, the seat cushion frame F1 or the like may function as the support member.

In the above embodiment, the car seat S used in a car has been taken as an example of a vehicle seat. However, the present invention is not limited to the car seat and applicable to other vehicle seat, such as a seat for a marine vessel and a seat for an aircraft.

It is to be noted that as long as the side portion constituent portions have a hardness to such an extent as to prevent the cushion member from being shifted excessively to the right or to the left (or a hardness to such an extent as to prevent foreign objects from entering into a space formed between the support member and the back board), the amount of compression of the side portion constituent portions can be determined appropriately based on experiments, simulations or the like.

1. A vehicle seat comprising:
a cushion member;
a support member configured to support right and left portions of the cushion member; and
a compressing member configured to compress side portion constituent portions which constitute the right and left portions of the cushion member.

2. The vehicle seat according to claim 1, wherein the cushion member is put over the support member from a front side so as to support a back of an occupant,
wherein a back board is provided at a rear side of the support member such that a gap is formed between each of right and left end portions of the back board and the support member, and
wherein the side portion constituent portions are arranged to fill the gap formed between the support member and each of the right and left end portions of the back board.

3. The vehicle seat according to claim 2, wherein the compressing member comprises the back board and a skin member configured to cover the cushion member, and
wherein the side portion constituent portions of the cushion member are compressed by being held between the skin member and the support member, and further compressed by the back board via the skin member.

4. The vehicle seat according to claim 2, wherein a rod-like member configured to support the cushion member on an inner side of the cushion member is provided between the support member and each of the right and left end portions of the back board.

5. The vehicle seat according to claim 4, wherein in a space between the support member and at least one of the right and left end portions of the hack board, the rod-like member and a side portion constituent portion of the cushion member are arranged one above another.

6. The vehicle seat according to claim 5, wherein the support member comprises main side frames constituting right and left middle portions of a seat back frame, and lower side frames fixed to lower portions of the main side frames, each lower side frame having a width greater than that of an upper portion of a corresponding main side frame, and
wherein the side portion constituent portion of the cushion member is supported by the lower side frame.

7. The vehicle seat according to claim 6, wherein the rod-like member is fixed at a position above a position in which the main side frame and the lower side frame are fixed.

8. The vehicle seat according to claim 5, wherein a rear surface of the cushion member has stepped portions configured to conform to upper portions of both right and left end edges of the back board.

9. The vehicle seat according to claim 8, wherein each of the stepped portions consists of a plurality of portions including an inner portion which is located laterally inward and constitutes a lower part of the stepped portion, the inner portion being provided in a region corresponding to a region in which the rod-like member is provided,
wherein the side portion constituent portion of the cushion member is configured to be higher than the inner portion, and
wherein a rear surface of the inner portion and a rear surface of the side portion constituent portion are connected by a gently sloped surface.

10. The vehicle seat according to claim 1, wherein the side portion constituent portions of the cushion member are compressed by the compressing member to an amount not less than 40 mm.

11. The vehicle seat according to claim 8, wherein each of the stepped portions consists of a plurality of portions including an inner portion which is located laterally inward and constitutes a lower part of the stepped portion, the both right and left end edges of the back board being located at the inner portions.

12. The vehicle seat according to claim 11, wherein the cushion member is received between the rod-like member and each of the right and left end portions of the back board.
